(19) United States
(12) Patent Application Publication
(10) Pub. No.: US 2015/0206343 A1
(43) Pub. Date: Jul. 23, 2015

(54) METHOD AND APPARATUS FOR EVALUATING ENVIRONMENTAL STRUCTURES FOR IN-SITU CONTENT AUGMENTATION

(71) Applicant: Nokia Corporation, Helsinki (FI)

(72) Inventors: Ville-Veikko MATTILA, Tampere (FI); Matei STROILA, Chicago, IL (US)

(73) Assignee: Nokia Corporation, Helsinki (FI)

(21) Appl. No.: 14/157,984

(22) Filed: Jan. 17, 2014

(51) Int. Cl. G06T 17/20; H04W 4/02; G06T 19/00

(52) U.S. Cl. CPC G06T 17/20; G06T 19/006; H04W 4/02; G06T 2215/16; G06T 2219/2004

(57) ABSTRACT

An approach is provided for determining three-dimensional mesh data associated with one or more object surfaces depicted in at least one image. The approach involves processing and/or facilitating a processing of the three-dimensional mesh data, the at least one image, or a combination thereof to determine one or more visual features of the one or more object surfaces. The approach further involves determining at least one score indicating a suitability for in-situ augmentation of the one or more object surfaces with at least one content presentation based, at least in part, on the one or more visual features.

### BACKGROUND

Service providers and device manufacturers (e.g., wireless, cellular, etc.) are continually challenged to deliver value and convenience to consumers by, for example, providing compelling network services. One area of interest has been the development of content distribution via location-based services (e.g. navigation services, mapping services, augmented reality applications etc.). For example, service providers may perform in-situ augmentation of structures present in an augmented reality user interface to present content (e.g., advertisements, messages, notifications, etc.) to users. However, the ability to present an accurate and stable alignment of contents on one or more structures in an environment varies according to their visual features. For example, the complex textures of one or more building facades may adversely affect the display of virtual contents attached on them because of the complexity in detecting their visual features. As a result, service providers face significant technical challenges in presenting an accurate alignment of content for a consistent user experience.

### SOME EXAMPLE EMBODIMENTS

Therefore, there is a need for an approach for calculating visual features for at least one object surface within an environment to determine its suitability for in-situ augmentation with at least one content presentation.

According to one embodiment, a method comprises determining three-dimensional mesh data associated with one or more object surfaces depicted in at least one image. The method also comprises processing and/or facilitating a processing of the three-dimensional mesh data, the at least one image, or a combination thereof to determine one or more visual features of the one or more object surfaces. The method further comprises determining at least one score indicating a suitability for in-situ augmentation of the one or more object surfaces with at least one content presentation based, at least in part, on the one or more visual features.

According to another embodiment, an apparatus comprises at least one processor, and at least one memory including computer program code for one or more computer programs, the at least one memory and the computer program code configured to, with the at least one processor, cause, at least in part, the apparatus to determine three-dimensional mesh data associated with one or more object surfaces depicted in at least one image. The apparatus is also caused to process and/or facilitate a processing of the three-dimensional mesh data, the at least one image, or a combination thereof to determine one or more visual features of the one or more object surfaces. The apparatus is further caused to determine at least one score indicating a suitability for in-situ augmentation of the one or more object surfaces with at least one content presentation based, at least in part, on the one or more visual features.

According to another embodiment, a computer-readable storage medium carries one or more sequences of one or more instructions which, when executed by one or more processors, cause, at least in part, an apparatus to determine three-dimensional mesh data associated with one or more object surfaces depicted in at least one image. The apparatus is also caused to process and/or facilitate a processing of the three-dimensional mesh data, the at least one image, or a combination thereof to determine one or more visual features of the one or more object surfaces. The apparatus is further caused to determine at least one score indicating a suitability for in-situ augmentation of the one or more object surfaces with at least one content presentation based, at least in part, on the one or more visual features.

According to another embodiment, an apparatus comprises means for determining three-dimensional mesh data associated with one or more object surfaces depicted in at least one image. The apparatus also comprises means for processing and/or facilitating a processing of the three-dimensional mesh data, the at least one image, or a combination thereof to determine one or more visual features of the one or more object surfaces. The apparatus further comprises means for determining at least one score indicating a suitability for in-situ augmentation of the one or more object surfaces with at least one content presentation based, at least in part, on the one or more visual features.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of calculating visual features for at least one object surface within an environment to determine its suitability for in-situ augmentation with at least one content presentation, according to one embodiment;

FIG. 2 is a diagram of the components of the display platform 109, according to one embodiment;

FIG. 3 is a flowchart of a process for determining one or more visual features for one or more object surfaces depicted in at least one image for in-situ augmentation with at least one content presentation, according to one embodiment;

FIG. 4 is a flowchart of a process for determining a rendering of at least one content presentation on at least one of the one or more object surfaces based, at least in part, on visual features, according to one embodiment;

FIG. 5 is a flowchart of a process for processing of the three-dimensional mesh data and/or the at least one image to determine the noise level, the strength level, one or more features of across a plurality of scales, or a combination thereof, according to one embodiment;

FIG. 6 is a flowchart of a process for processing of the three-dimensional mesh data and/or the at least one image to determine at least one uniqueness level of the one or more features, one or more materials making up the one or more object surfaces, or a combination thereof, according to one embodiment;

FIG. 7 is a representation of a unified virtual advertisement experience in an augmented reality view and a photorealistic 3D map view, according to one example embodiment;

FIG. 8 is a user interface representation of different map views and their transitions on the UE 101 of the at least one user, according to one example embodiment;

FIG. 9 is a pictorial representation of processing pipeline for camera pose estimation making use of 3D mesh true data, according to one example embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for calculating visual features for at least one object surface within an environment to determine its suitability for in-situ augmentation with at least one content presentation are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

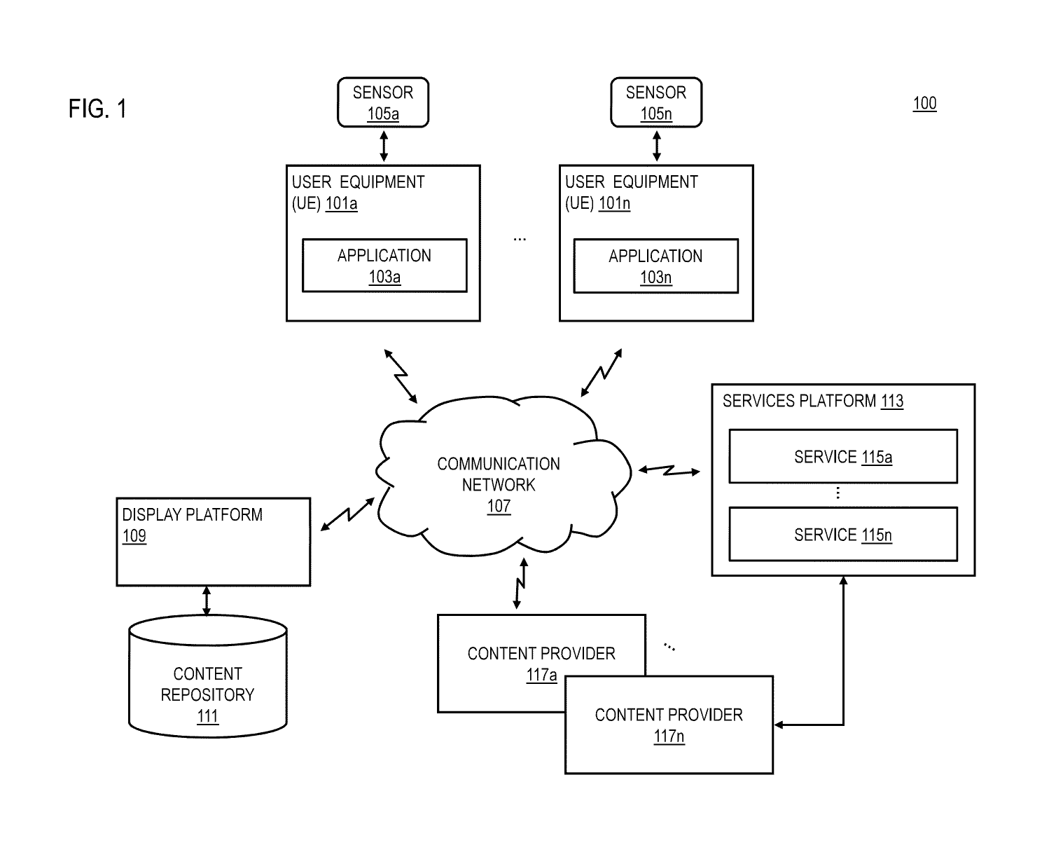

FIG. 1 is a diagram of a system capable of calculating visual features for at least one object surface within an environment to determine its suitability for in-situ augmentation with at least one content presentation, according to one embodiment. In one example embodiment, service providers may incorporate high-definition spherical panoramas of street views, LiDAR (Light Detection and Ranging) point clouds and IMU (Inertial Measurement Unit) tracking that can be used to register the imagery and point clouds with real-world 3D coordinates. The LiDAR point clouds can serve as the basis for creating registered 3D city models, consisting of, for example, 3D meshes of buildings and terrains, while the street view images can be projected onto the models to achieve photorealistic 3D maps. Such 3D models enables virtual contents to be accurately attached to, for example, building facades, making the contents look natural as appearing in alignment to real city structures. Service providers aims at providing the most comprehensive map experience by letting users to experience the world and location information through several aligned map views, such as 3D map and augmented reality views, wherein virtual advertisement appears consistently in different map views. In particular, new camera pose estimation technology is required to achieve an accurate and stable alignment of virtual advertisement to city structures in augmented reality as on photorealistic 3D maps. As a result, service provider enables camera pose estimation and visual tracking of mobile device by matching image 2D features to pre-computed visual words that are associated to 3D structures or point clouds. The performance of camera pose estimation technology depends heavily on the capability of detecting visual 2D features in street views, for example, on the building facades. Typically, buildings with more complex textures, i.e., buildings with window openings, balconies, brick walls and decorative patterns, provide rich basis for detecting visual features, while modern architecture with glass walls or unicolor metal covers may be challenging. In this way, the ability to present virtual advertisement accurately in augmented reality views varies from building to building. An approach is needed to maintain a consistent virtual advertisement experience when switching between augmented reality and photorealistic 3D map views. The current sensor-based augmented reality provides bad misalignment between the real and virtual views due to the errors in GPS location reading and sensor readings (magnetometer, accelerometer and gyroscope).

However, the 3D meshes of buildings provide means to calculate features for each building facade, possibly separately for each viewing angles. The panoramic street view images can be analyzed a priori to calculate their visual features. Hence, the ability for accurate augmentation could also be estimated for cases where the user is looking at a building facade from sideward. In this way, system 100 of FIG. 1 introduces the capability to calculate visual features for each building facade in panoramic street view images presenting the facade from different viewing angles to create a database of buildings and their facades that can be accurately augmented in-situ from the different viewing angles for virtual advertisement. The same information may be utilized to determine placement of virtual advertisement on photorealistic 3D maps to achieve a consistent experience when switching between the map views, for example, switching between augmented reality and virtual reality. In one embodiment, the selected virtual content may be provided as a part of a global positioning system based navigational service. In addition to this, one of the limitations of the current mobile technology is the difficulty in real time calculation of the augmented reality view. Accordingly, the system 100 of FIG. 1 also introduces the capability to pre-calculate all the information for the augmented reality view and the 3D view in the cloud for a comprehensive mapping experience.

As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the display platform 109 via the communication network 107.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as content provisioning services, location-based service applications, navigation applications, camera/imaging application, media player applications, social networking applications, calendar applications, and the like. In one embodiment, one of the applications 103 at the UE 101 may act as a client for the display platform 109 and perform one or more functions associated with the functions of the display platform 109. In one scenario, users are able to use different map modes, for example, photorealistic reading map, augmented reality map, etc., via one or more camera applications. The one or more cameras may implement various intelligent components to achieve a real alignment between the virtual and 3D pictures. In one scenario, dual camera technology may be implemented to create more visual data. In another scenario, the display platform 109 may implement depth image to quantify the planarity, which is important for indoor environment.

By way of example, the sensors 105 may be any type of sensor. In certain embodiments, the sensors 105 may include, for example, a camera/imaging sensor for gathering image data, an audio recorder for gathering audio data, a global positioning sensor for gathering location data, a network detection sensor for detecting wireless signals or network data, temporal information and the like. In one scenario, the sensors 105 may include location sensors (e.g., GPS), light sensors, oriental sensors augmented with height sensor and acceleration sensor, tilt sensors, moisture sensors, pressure sensors, audio sensors (e.g., microphone), or receivers for different short-range communications (e.g., Bluetooth, WiFi, etc.). In one scenario, the one or more sensors 105 may detect properties for one or more display surfaces, for example, if the sensors 105 determines the surface for at least one object to be smooth, such feature may be implemented in the calculation of scores and/or ranking In another scenario, the one or more UE 101 may have structure sensors, whereby the sensor data may be calculated either on the cloud or by the UE 101.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the display platform 109 may be a platform with multiple interconnected components. The display platform 109 may include multiple servers, intelligent networking devices, computing devices, components and corresponding software for calculating visual features for at least one object surface within an environment to determine its suitability for in-situ augmentation with at least one content presentation. In one embodiment, the 3D meshes of buildings define the regions of buildings in panoramic street view images that present facades that are visible to the streets. The display platform 109 may calculate visual features for each facade on the panoramic images that present the facade from different viewing angles. The display platform 109 may measure how dense the feature set is on each facade and how noisy the features are compared to an assumption of having a planar facade, i.e., how much the features' 3D points differ from the plane to estimate the expected performance of in-situ augmentation. Basically, the more dense and less noisy a feature set is, the better in-situ augmentation may be achieved. This enables the creation of an indexing table and a database of how building facades should be prioritized to place virtual contents on them as advertisements so as the experience being consistent between augmented reality and photorealistic 3D map views. In one embodiment, the display platform 109 may estimate the ability to augment buildings in cities based on analyzing panoramic images and LiDAR data a piori on the server side. This would achieve a clear strategy of how virtual advertisement should be placed to guarantee a consistent user experience. Such information on the potential coverage of virtual advertisement as an in-situ and a remote experience should be valuable to advertisers to design their marketing campaigns.

In one embodiment, the display platform 109 may process and/or facilitate a processing of one or more data to calculate visual features for at least one display surface associated with at least one object surface within an environment. In another embodiment, the display platform 109 may cause, at least in part, a ranking of regions in street view images corresponding to one or more object surface based, at least in part, on the quality of visual features. In a further embodiment, the display platform 109 may cause, at least in part, a matching and a placing of virtual contents on at least one object surface, for example, building facade based, at least in part, on the ranking In one embodiment, the visual features include display surface information, content information associated with the one or more display surfaces, or a combination thereof. In one example embodiment, the display platform 109 may cause, at least in part, a measurement to estimate the performance of in-situ augmentation based, at least in part, on density of at least one building facade, other features for at least one building facade, or a combination thereof.

In one embodiment, the display platform 109 causes, at least in part, a presentation of at least one display surface associated with at least one object surface, for example, building facades from different viewing angles to cause, at least in part, an accurate in-situ augmentation of virtual contents with at least one planar surface. Subsequently, the display platform 109 determines a placement for virtual content on at least one display surface associated with at least one building facade based, at least in part, on calculation of visual features for at least one display surface associated with at least one building facade. In another embodiment, the display platform 109 causes at least in part, an alignment between the real view and the virtual view for consistent virtual content experience when switching between augmented reality view and photorealistic 3D map view. In a further embodiment, the display platform 109 may implement a mixed reality application, whereby the real and virtual objects are merged to produce new visualizations where physical and digital objects co-exist and interact in real time. Such mixed reality applications are implemented for both augmented reality and virtual reality views.

In one embodiment, the display platform 109 may create content repository 111 wherein visual features are calculated for each object surface, for example, building facades (in panoramic street view images) from different viewing angles. In another embodiment, the display platform 109 may receive content information from various sources, for example, the sensors 105, third-party content providers, databases, etc. and may store the received information on the content repository 111. The content repository 111 may include identifiers to the UE 101 as well as associated information. Further, the information may be any multiple types of information that can provide means for aiding in the content provisioning process. In a further embodiment, the content repository 111 assists by providing information on identifying object surfaces, for example, building facade to place the virtual advertisement in photorealistic 3D map so as to appear consistently in both augmented reality and photorealistic 3D map view.

The services platform 113 may include any type of service. By way of example, the services platform 113 may include content (e.g., audio, video, images, etc.) provisioning services, application services, storage services, contextual information determination services, location based services, social networking services, information (e.g., weather, news, etc.) based services, etc. In one embodiment, the services platform 113 may interact with the UE 101, the display platform 109 and the content provider 117a-117n (hereinafter content provider 117) to supplement or aid in the processing of the content information.

By way of example, services 115a-115n (hereinafter services 115) may be an online service that reflects interests and/or activities of users. In one scenario, the services 115 provide representations of each user (e.g., a profile), his/her social links, and a variety of additional information. The services 115 allow users to share media information, location information, activities information, contextual information, and interests within their individual networks, and provides for data portability.

The content provider 117 may provide content to the UE 101, the display platform 109, and the services 115 of the services platform 113. The content provided may be any type of content, such as image content, video content, audio content, textual content, etc. In one embodiment, the content provider 117 may provide content that may supplement content of the applications 103, the sensors 105, the content repository 111 or a combination thereof. By way of example, the content provider 117 may provide content that may aid in causing a generation of at least one request to capture at least one content presentation. In one embodiment, the content provider 117 may also store content associated with the UE 101, the display platform 109, and the services 115 of the services platform 113. In another embodiment, the content provider 117 may manage access to a central repository of data, and offer a consistent, standard interface to data, such as a repository of users' navigational data content.

By way of example, the UE 101, the display platform 109, the services platform 113, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

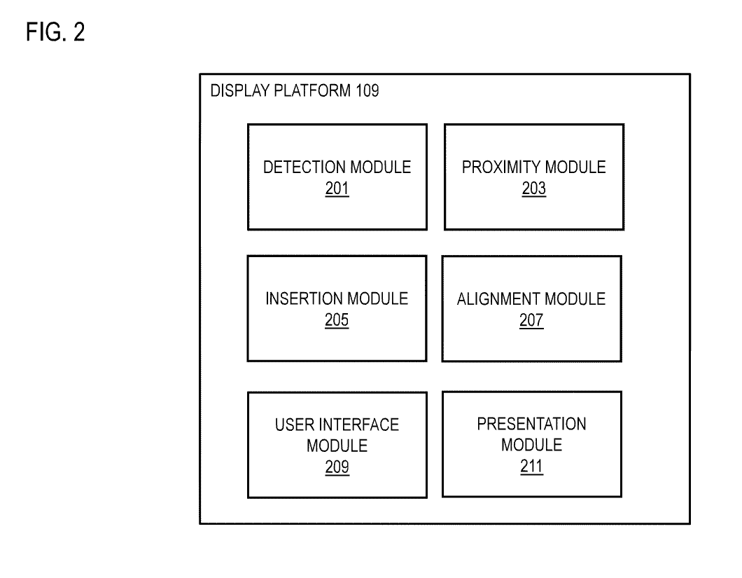

FIG. 2 is a diagram of the components of the display platform 109, according to one embodiment. By way of example, the display platform 109 includes one or more components for calculating visual features for at least one object surface within an environment to determine its suitability for in-situ augmentation with at least one content presentation. It is contemplated that the functions of these components may be combined in one or more components or performed by other components of equivalent functionality. In this embodiment, the display platform 109 includes a detection module 201, a proximity module 203, an insertion module 205, an alignment module 207, a user interface module 209 and a presentation module 211.

In one embodiment, the detection module 201 may determine similarities between various display surfaces and the content information to determine appropriate groupings of the surfaces and the content information. In one embodiment, the detection module 201 may determine how much content should be distributed and displayed or associated between display surfaces and content information. In another embodiment, the detection module 201 may process one or more data to calculate visual features for at least one display surface associated with at least one object surface within an environment. In a further embodiment, the detection module 201 may cause a ranking of regions in street view images corresponding to one or more building facades based, at least in part, on the quality of visual features.

In one embodiment, the proximity module 203 may cause transfer of one or more contents to the UE 101 when UE 101's are proximate to one or more surfaces or structures. For example, the proximity module 203 may interact with application 103 where application 103 may activate UE 101 to receive or request detection of display surfaces where the sensors 105 determines that at least one UE 101 is entering an area where the display platform 109 has knowledge of available display surfaces. In one embodiment, the proximity module 203 may monitor the locations of the UE 101, when UE 101 are within a predetermined radius of available display surfaces the proximity module 203 may prompt transmission of one or more contents as virtual advertisements. In another embodiment, the proximity module 203 may process sensor data associated with, for instance, UE 101 to incorporate the fixing of one or more contents as virtual advertisements in relation to the display surfaces or structures in the augmented reality view. In a further embodiment, the proximity module 203 may interact with the UE 101 to determine the position and orientation of the UE 101. Then, the proximity module 203 may compare the location and direction of the UE 101 so that the virtual contents displayed on the UE 101 are fixed to the display surfaces and structures relevant to the user of the UE 101. In other words, as the UE 101 moves, the proximity module 203 ensures that the virtual content are fixed on one or more display surfaces that corresponds to the user's movement. In doing so, rendering of content information may match how a user may experience content item display in real life.

In one embodiment, the insertion module 205 may request contents from, for example, the content repository 111, and/or one or more third-party content providers, such as content providers 117. As such, the insertion module 205 may generate requests for contents based on navigational information (e.g., predetermined routing directions), spatial positioning (or location) of subscribers, and/or user profile information, such as one or more parameters, criteria, information etc., of a user-defined advertisement policy. In one embodiment, the insertion module 205 may also be configured to embed, correlate, combine, and/or sequence received contents with navigational information. In another embodiment, a request for advertisement content based on one or more variables, such as the location of the UE 101, routing directions determined by the sensors 105, and/or any other suitable criterion, such as predetermined criteria specified by an administrator of the advertisement-based navigational services of system 100. In a further embodiment, the insertion module may cause a matching and a placing of virtual contents on at least one object surface based, at least in part, on their visual features.

In one embodiment, the alignment module 207 may determine the type of content to select and/or retrieve for display alongside the navigational information. In one example embodiment, the display platform 109 may receive, via communication network 107, requests for contents from, for example, UE 101. For example, a request for advertisements may be a request for location-based advertisements. As such, the display platform 109 may port the advertisement request to the alignment module 207 for determining a type of content to select and/or retrieve for advertisement purposes. The alignment module 207 may extract (or otherwise obtain) “current” positioning information and/or navigational information (e.g., routing directions) corresponding to a particular UE 101 from a request for advertisement content associated with UE 101, or may retrieve such information from the display platform 109, the sensors 105 or any other suitable source. Subsequently, the alignment module 207 may determine a placement for virtual content on at least one display surface associated with at least one object surface based, at least in part, on visual features for at least one display surface, navigation information, or a combination thereof. In another embodiment, the alignment module 207 causes, at least in part, an alignment between the real view and the virtual view for consistent virtual content experience when switching between augmented reality view and photorealistic 3D map view.

In one embodiment, the user interface module 209 may be configured for exchanging information between UE 101 and the content repository 111, and/or one or more third-party content providers. In another embodiment, the user interface module 209 enables presentation of a graphical user interface (GUI) for displaying map images with content information in connection to a selected destination. For example, the user interface module 209 executes a GUI application configured to provide users with advertisement-based navigational services wherein one or more contents are placed on one or more display surfaces associated with one or more object surfaces depicted in at least one image. The user interface module 209 employs various application programming interfaces (APIs) or other function calls corresponding to the applications 103 of UE 101, thus enabling the display of graphics primitives such as menus, buttons, data entry fields, etc., for generating the user interface elements. Still further, the user interface module 209 may be configured to operate in connection with augmented reality (AR) processing techniques, wherein various different applications, graphic elements and features may interact. For example, the user interface module 209 may coordinate the presentation of augmented reality map images in conjunction with content information for a given location or in response to a selected destination. In a further embodiment, the user interface module 209 may cause presentation of at least one display surface associated with at least one object surfaces from different viewing angles for accurate in-situ augmentation of virtual contents.

In one embodiment, the presentation module 211 may process the contents to determine display surfaces, and may recognize display spaces via a pattern match algorithm. For instance, the presentation module 211 may determine sizes or dimensions to identify display surfaces. In one scenario, the presentation module 211 may employ image recognition, including text, area/size, and/or frame. In another embodiment, the presentation module 211 may cause a presentation of content information in the most suitable manner for consistent user experience.

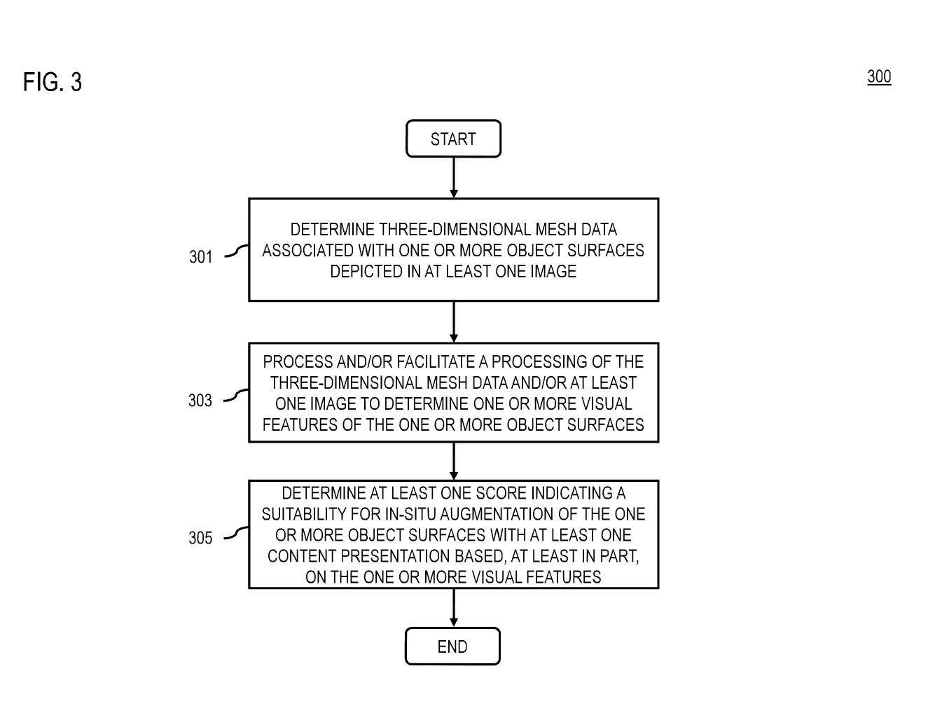

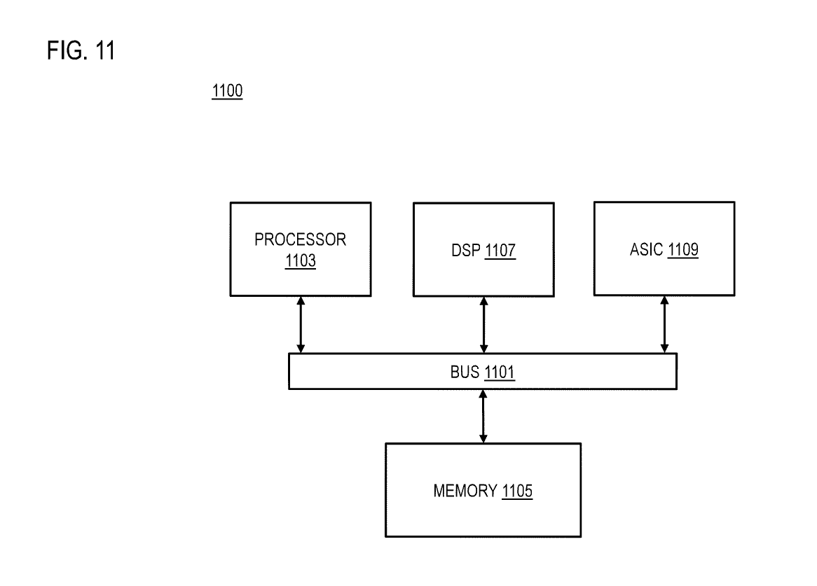

FIG. 3 is a flowchart of a process for determining one or more visual features for one or more object surfaces depicted in at least one image for in-situ augmentation with at least one content presentation, according to one embodiment. In one embodiment, the display platform 109 performs the process 300 and is implemented in, for instance, a chip set including a processor and a memory as shown in FIG. 11.

In step 301, the display platform 109 determines three-dimensional mesh data associated with one or more object surfaces depicted in at least one image. In one embodiment, the at least one image includes a plurality of images depicting the one or more object surfaces from one or more viewing angles, under one or more contextual conditions, or a combination thereof. In one example embodiment, the display platform 109 causes, at least in part, a presentation of at least one display surface associated with at least one building facade from different viewing angles to cause, at least in part, an accurate in-situ augmentation of virtual content with at least one planar surface. Subsequently, the display platform 109 determines a placement for virtual contents on at least one display surface associated with at least one building facade based, at least in part, on calculation of visual features for at least one display surface associated with at least one building facade.

In step 303, the display platform 109 processes and/or facilitates a processing of the three-dimensional mesh data, the at least one image, or a combination thereof to determine one or more visual features of the one or more object surfaces. In one embodiment, the display platform 109 may implement one or more quality measures for determining visual features for subsequent matching and augmentation with planar surfaces, wherein the visual features includes display surface information, content information associated with the one or more display surfaces, or a combination thereof. The display platform 109 may determine object surfaces with richer texture and more planarity as suitable surfaces for detection and tracking The texture may be determined from one or more virtual objects and not necessarily from real objects. In another embodiment, the display platform 109 may process one or more data to calculate visual features for at least one display surface associated with one or more objects within an environment. In one example embodiment, the display platform 109 may determine the density, planarity, strength, scale, uniqueness, or a combination thereof for one or more object surfaces to calculate the quality of visual features. In another example embodiment, the display platform 109 may implement blob detection mechanism to detect regions in at least one digital image that differ in properties as compared to areas surrounding those regions.

In step 305, the display platform 109 determines at least one score indicating a suitability for in-situ augmentation of the one or more object surfaces with at least one content presentation based, at least in part, on the one or more visual features. In one embodiment, the display platform 109 causes, at least in part, a registration, a tracking, or a combination thereof, of one or more display surfaces associated with one or more object surfaces to estimate the success of placement of one or more digital contents on one or more display surfaces. In another embodiment, the display platform 109 causes, at least in part, an evaluation of one or more object surfaces based, at least in part, on the texture, the planarity, or a combination thereof, for prioritizing at least one object surface for placement of virtual contents for consistent experience between the augmented reality and the photorealistic 3D map views. In a further embodiment, the display platform 109 causes, at least in part, an alignment between the real view and the virtual view for consistent virtual content experience when switching between augmented reality view and photorealistic 3D map view. In one example embodiment, the one or more content may be any content that can be placed or is requested to be placed on any physical structure in an environment.

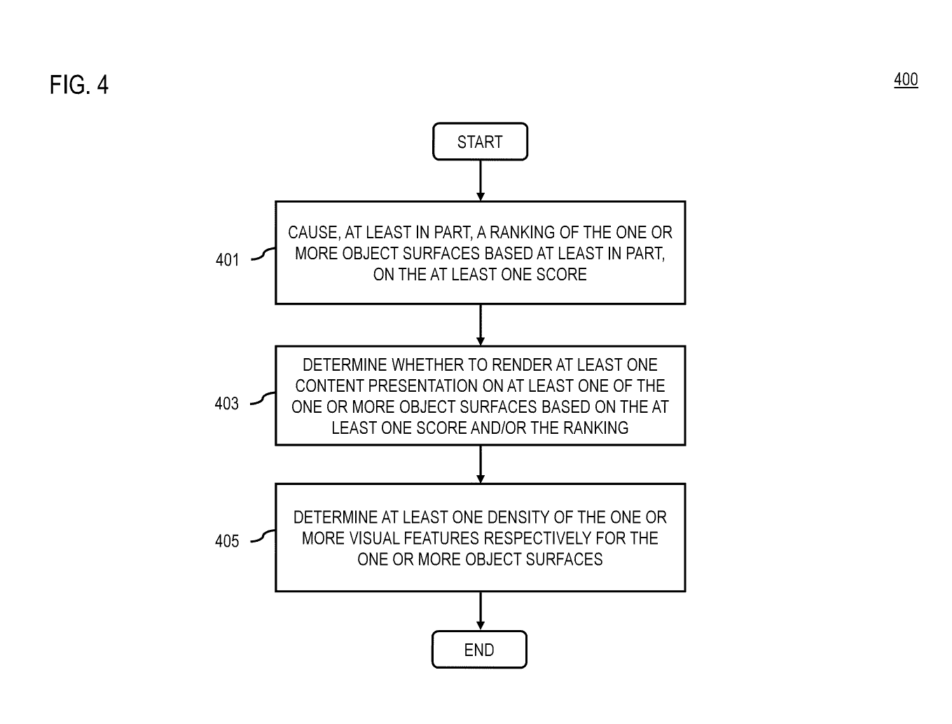

FIG. 4 is a flowchart of a process for determining a rendering of at least one content presentation on at least one of the one or more object surfaces based, at least in part, on visual features, according to one embodiment. In one embodiment, the display platform 109 performs the process 400 and is implemented in, for instance, a chip set including a processor and a memory as shown in FIG. 11.

In step 401, the display platform 109 causes, at least in part, a ranking of the one or more object surfaces based, at least in part, on the at least one score. In one embodiment, the display platform 109 causes, at least in part, a ranking of regions in street view images corresponding to one or more object surfaces based, at least in part, on the quality of visual features. Then, the display platform 109 causes, at least in part, a matching and a placing virtual content on at least one object surface based, at least in part, on the ranking In another embodiment, the display platform 109 causes, at least in part, analyzing of one or more images, one or more object surfaces, or a combination thereof, to estimate the ability to augment to one or more object surfaces, wherein the suitability of at least one object surface is determined based, at least in part, on the ranking In one example embodiment, the display platform 109 causes, at least in part, a ranking of the overlaid information for providing a comprehensive map view, wherein the display platform 109 estimates proper placements for one or more contents to cause a proper alignment of contents between the augmented reality map view and the photorealistic 3D map view. In such manner, the display platform 109 ensures that the content appears the same in the augmented reality view and the photorealistic 3D view. In another example embodiment, the one or more ranking may further be based on virtual content for one or more display surfaces.

In step 403, the display platform 109 determines whether to render the at least one content presentation on at least one of the one or more object surfaces based, at least in part, on the at least one score, the ranking, or a combination thereof. In one embodiment, the display platform 109 causes, at least in part, analyzing of one or more street views to estimate the performance of virtual contents placements based, at least in part, on camera-based registration, in-situ tracking, or a combination thereof.

In step 405, the display platform 109 determines at least one density of the one or more visual features respectively for the one or more object surfaces, wherein the at least one score is further based, at least in part, on the at least one density of the one or more visual features. In one embodiment, the measure to estimate the expected performance of in-situ augmentation may relate to how dense the feature set is on each facade. Basically, a better in-situ augmentation may be achieved through a denser a feature set. In another embodiment, the display platform 109 causes, at least in part, a measurement to estimate the performance of in-situ augmentation based, at least in part, on density of at least one object surface, other features for at least one object surface, or a combination thereof. In one example embodiment, the display platform 109 may rank the quality of image matching, wherein switch view imagery with virtual contents may be used to find the area with the best quality for augmentation.

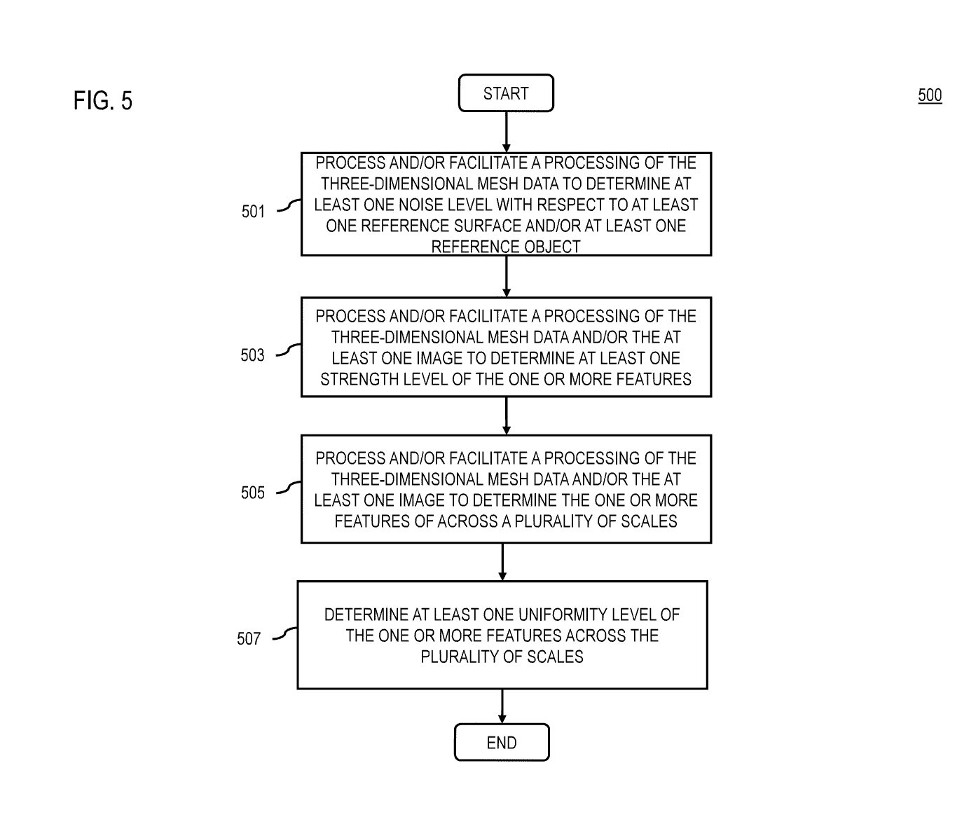

FIG. 5 is a flowchart of a process for processing of the three-dimensional mesh data and/or the at least one image to determine the noise level, the strength level, one or more features of across a plurality of scales, or a combination thereof, according to one embodiment. In one embodiment, the display platform 109 performs the process 500 and is implemented in, for instance, a chip set including a processor and a memory as shown in FIG. 11.

In step 501, the display platform 109 processes and/or facilitates a processing of the three-dimensional mesh data to determine at least one noise level with respect to at least one reference surface, at least one reference object, or a combination thereof, wherein the at least one score is further based, at least in part, on the at least one noise level. In one embodiment, the measure to estimate the expected performance of in-situ augmentation could relate to how noisy the features are compared to an assumption of having a planar facade, i.e., how much the feature of 3D points differ from the plane. Basically, the less noisy a feature set is, the better in-situ augmentation may be achieved. In one example embodiment, noise may refer to the suitability for one or more display surfaces to be tracked and the possibility for one or more display surfaces to be a planar surface. As a result, a less noisy feature results in a suitable tracking and the likelihood of being a planar surface. In another example embodiment, the display platform 109 may measure the underlying 3D models and apply it for both indoor and/or outdoor display surfaces for placement of one or more contents.

In step 503, the display platform 109 processes and/or facilitates a processing of the three-dimensional mesh data, the at least one image, or a combination thereof to determine at least one strength level of the one or more features, wherein the at least one score is further based, at least in part, on the at least one strength level. In one scenario, a quality measure for determining visual feature may be the total feature strength in a normalized image of an object surface (intensity normalization). The image features are usually computed using image gradients, and a stronger gradient helps in accurate detection and tracking In one scenario, some display surfaces have stronger gradients in the image and strong corners (where the edges meet), such attributes ranks them higher as compared to other display surfaces with weak gradients.

In step 505, the display platform 109 processes and/or facilitates a processing of the three-dimensional mesh data, the at least one image, or a combination thereof to determine the one or more features of across a plurality of scales. In one scenario, a quality measure for determining visual feature could be the uniformity in the distribution of the features' scale. The image features are computed at different scales using a pyramid of images generated by repeatedly subsampling and smoothing the original image. A coarser scale could help better at localization and tracking and finer scales could help with better identification of the object surfaces.

In step 507, the display platform 109 determines at least one uniformity level of the one or more features across the plurality of scales, wherein the at least one score is further based, at least in part, on the at least one uniformity level.

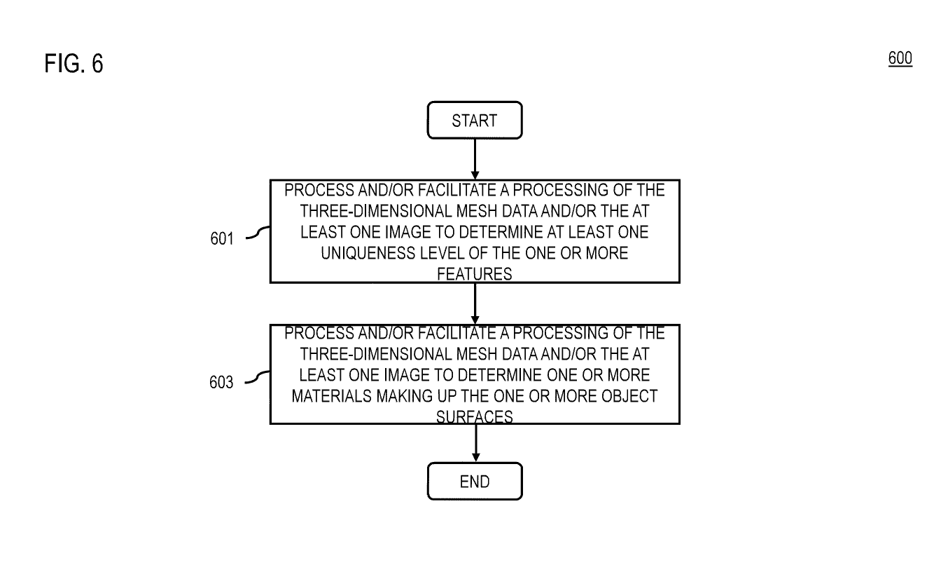

FIG. 6 is a flowchart of a process for processing of the three-dimensional mesh data and/or the at least one image to determine at least one uniqueness level of the one or more features, one or more materials making up the one or more object surfaces, or a combination thereof, according to one embodiment. In one embodiment, the display platform 109 performs the process 600 and is implemented in, for instance, a chip set including a processor and a memory as shown in FIG. 11.

In step 601, the display platform 109 processes and/or facilitates a processing of the three-dimensional mesh data, the at least one image, or a combination thereof to determine at least one uniqueness level of the one or more features, wherein the at least one score is further based, at least in part, on the at least one uniqueness level. In one example embodiment, numerous building facades have repeated structures (windows, etc.). The image features coming from these repeated patterns create ambiguities in the process of feature matching, as a result, unique features of one or more building facade helps with the disambiguation. The feature uniqueness can be quantified by finding self-matches in the features of a building facade and computing the ratio of the number of unique features (i.e., features without matches) to the number of repeated features. In one scenario, planar surfaces with repeated patterns are difficult to match, wherein recognition and interaction are more challenging. As a result, the display platform 109 may give high scores to one or more object surfaces, for example, building facade with unique features in terms of computer vision images.

In step 603, the display platform 109 processes and/or facilitates a processing of the three-dimensional mesh data, the at least one image, or a combination thereof to determine one or more materials making up the one or more object surfaces, wherein the at least one score is further based, at least in part, on the one or more materials. In one scenario, the percentage of glass and/or reflective material on the building facade may be a quality measure for determining visual feature. Such ephemeral features (i.e., glass and/or reflective material) make recognition and tracking difficult. For example, the glass reflections on the building facades produce new image features that can make the recognition and tracking processes very difficult. On the other hand, the shadows on the building facades with or without reflective materials can produce useful features, such as, high scores and/or better rankings, if they are consistent with the weather and/or the time of the day and/or the position of the camera and/or the position of the sun etc. These consistent features can be indexed and saved in the content repository 111 and may be retrieved in-situ using the specific conditions at the retrieval time. For example, a high-contrast pattern of the shadows on a building facade with no features (uniform color and/or a flat surface with no texture) may generate useful features for detection and tracking In one scenario, the display platform 109 may take into account the impact of dynamic environmental effects, such as, the weather, the time of the day, the season, etc., wherein the feasibility of in-situ augmentation may be evaluated based on analyzing the street view images that are captured under or are transformed to correspond to the impact of such dynamic issues. In one example embodiment, the display platform 109 may determine that the visual feature for one or more object surfaces depicted in at least one image may be visible at certain time of the day and/or at certain weather conditions. In another example embodiment, the display platform 109 may determine that the external pattern for at least one building facade may be clearly visible and/or registered from certain camera position and/or from certain position of the sun. In a further example embodiment, the display platform 109 may enhance user experience by providing street view imagery in diverse dynamic conditions. For example, the display platform 109 may provide one or more users with navigational services at certain time of the day and/or in a certain season and/or weather conditions, for enhanced navigational and augmented reality experience. In one embodiment, the display platform 109 may cause an accurate environmental lighting based, at least in part, on the time of the day, the position of the sun, the weather, and 3D geometry of the objects in the environment (i.e. buildings, trees, statutes etc.), whereby the display platform 109 may relight the street and may eliminate the shadows from the images to enhance user experience in mapping services.

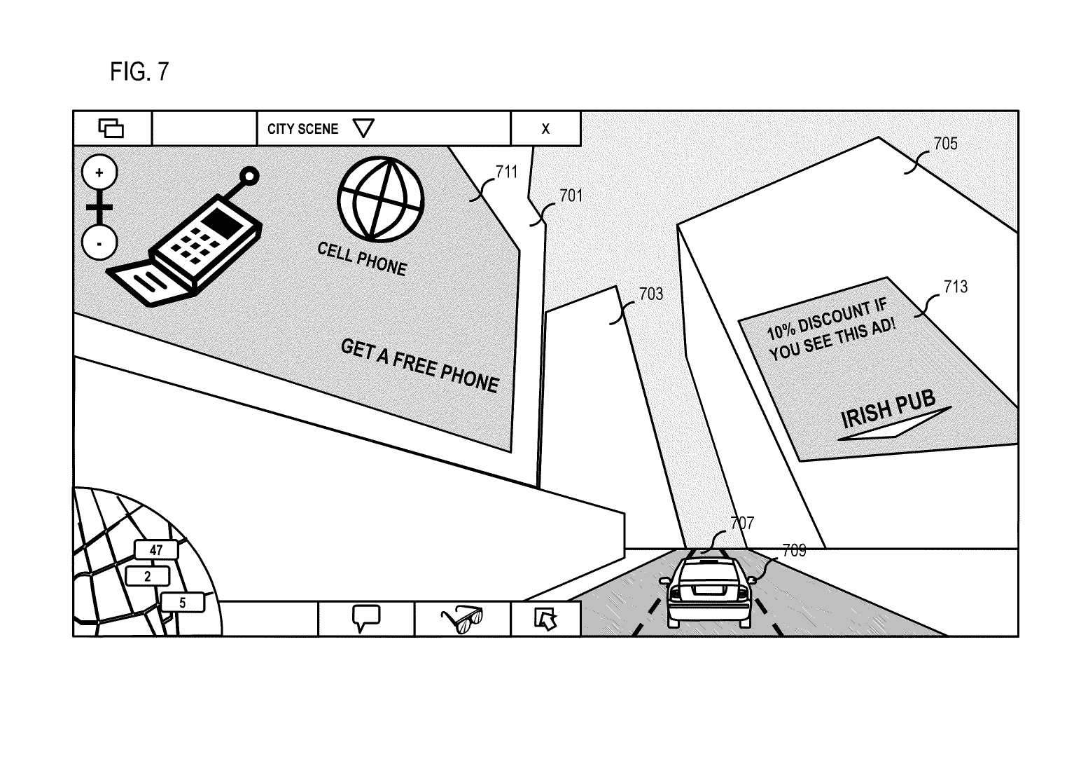

FIG. 7 is a representation of a unified virtual advertisement experience in an augmented reality view and a photorealistic 3D map view, according to one example embodiment. In one embodiment, the display platform 109 provides unified virtual advertisement experience when switching between augmented reality view and photorealistic 3D map view. In one scenario, the LIDAR point cloud creates registered 3D city models consisting of 3D meshes of buildings and terrains [701, 703, 705], while the street view images can be projected onto the models to achieve a photorealistic 3D maps [707, 709]. A virtual advertisement can be attached accurately to the building facade making the advertisement look natural [711, 713]. In another embodiment, the display platform 109 may create buildings database wherein visual features are calculated for each building facade (in panoramic street view images) from different viewing angles by processing the 3D mesh true data. In a further embodiment, the display platform 109 estimates how well the camera-based registration and tracking will perform in-situ by analyzing street views a priori on the server side. The measure to estimate the expected performance of in-situ augmentation could relate to how dense the feature set is on each facade and how noisy the features are compared to an assumption of having a planar facade, i.e., how much the features' 3D points differ from the plane. Basically, the more dense and less noisy a feature set is, the better in-situ augmentation may be achieved. The database helps to identify the building facade to place the virtual advertisement in photorealistic 3D map so as to appear consistently in both augmented reality and photorealistic 3D map view.

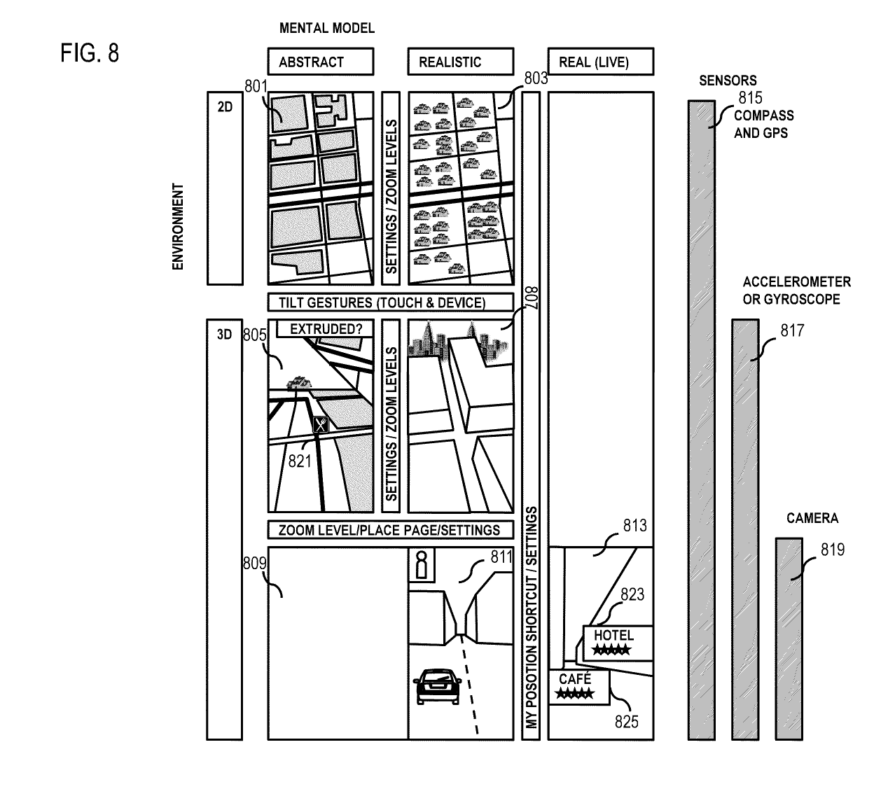

FIG. 8 is a user interface representation of different map views and their transitions on the UE 101 of the at least one user, according to one example embodiment. In one embodiment, the display platform 109 may provide a presentation of virtual advertisement in different map views [801, 803, 805, 807, 809, 811, 813]. The display platform 109 provides the most comprehensive map experience by letting the users to experience the world and location information through several aligned map views [801, 803, 805, 807, 809, 811, 813], such as 2D maps, 3D maps and augmented reality map views. In another embodiment, the display platform 109 provides a consistent presentation of virtual advertisements [821, 823, 825] in different map views. In particular, new camera pose estimation technology may be implemented to achieve an accurate and stable alignment of virtual advertisement to city structures in augmented reality as on photorealistic 3D map. Such accurate and stable alignment may be achieved via one or more sensors, for example, compass and GPS [815], accelerometer or gyroscope [817], and camera [819].

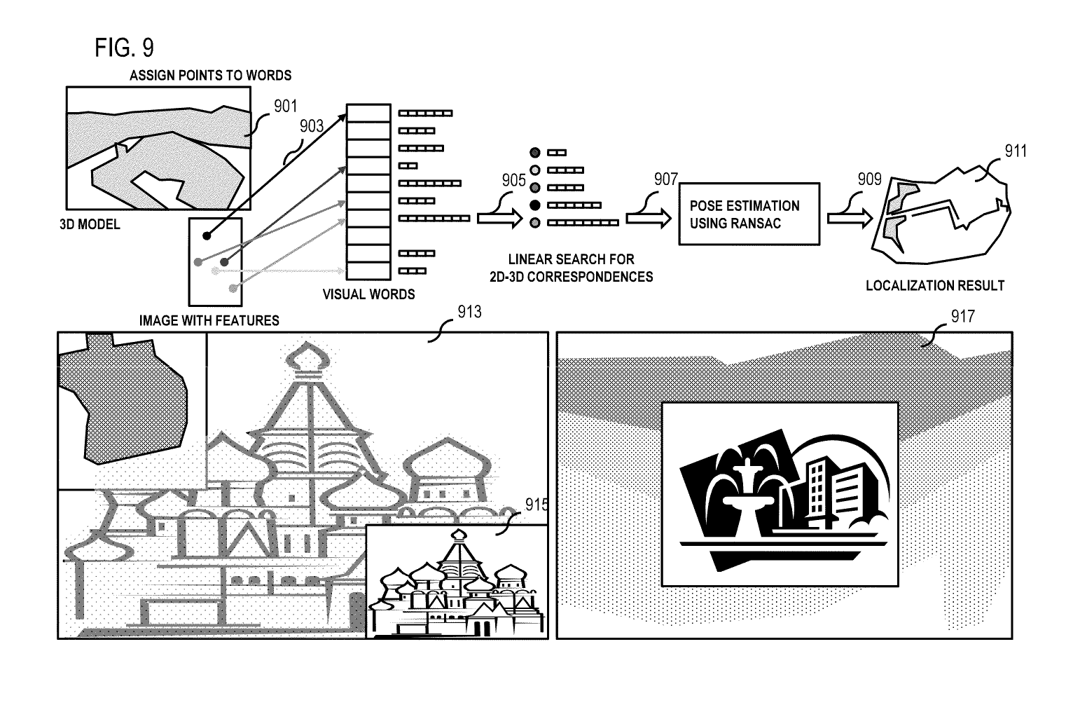

FIG. 9 is a pictorial representation of processing pipeline for camera pose estimation making use of 3D Mesh true data, according to one example embodiment. In one embodiment, the new camera pose estimation technology provides accurate and stable alignment of virtual advertisement to city structures in augmented reality as on photorealistic 3D maps [901]. The 3D mesh true data enables camera pose estimation and visual tracking [903] of mobile device by matching image 2D features [905] to pre-computed visual words that are associated with 3D structure or point clouds [907, 909, 911]. In one embodiment, the performance of the camera pose estimation technology depends on capability of detecting visual 2D features in street views [913, 915], for example, on the building facades. Typically, buildings with more complex textures [917], i.e., buildings with window openings, balconies, brick walls and decorative patterns, provide rich basis for detecting visual features, while modern architecture with class walls or unicolor metal covers may be challenging. In one example embodiment, the city structures may comprise of any physical object within an environment, for example, buildings, trees, statues, etc. In another example embodiment, the city structures may also include moving objects in the environment, for example, vehicles.

The processes described herein for calculating visual features for at least one object surface within an environment to determine its suitability for in-situ augmentation with at least one content presentation may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

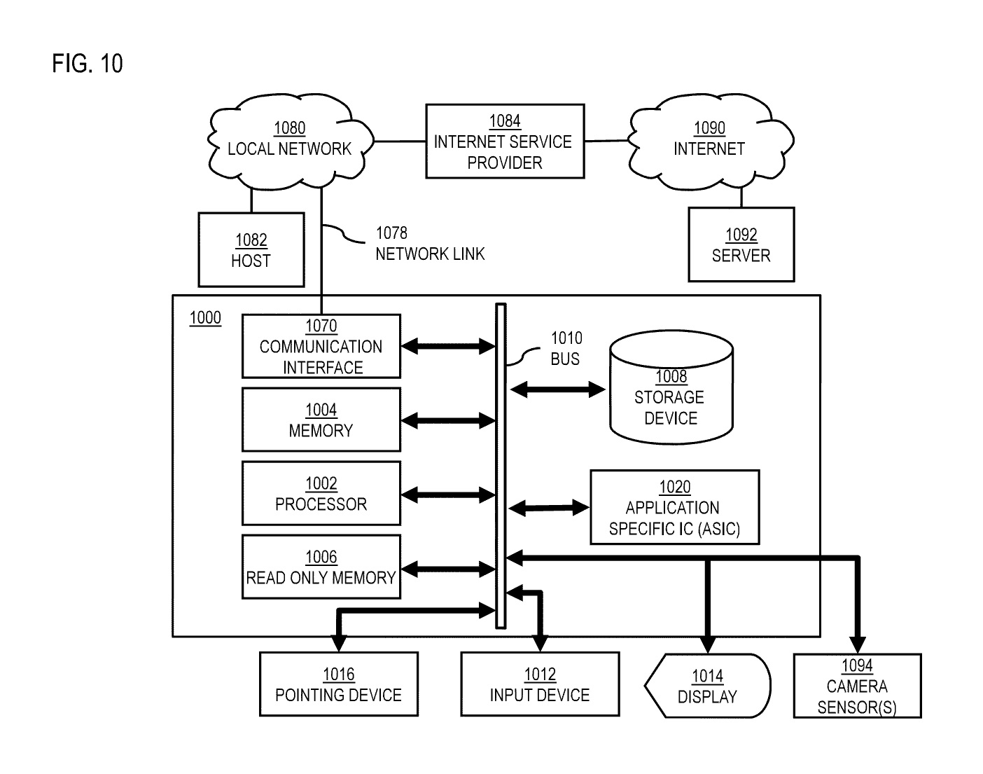

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to calculate visual features for at least one object surface within an environment to determine its suitability for in-situ augmentation with at least one content presentation as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of calculating visual features for at least one object surface within an environment to determine its suitability for in-situ augmentation with at least one content presentation.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to calculate visual features for at least one object surface within an environment to determine its suitability for in-situ augmentation with at least one content presentation. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random access memory (RAM) or any other dynamic storage device, stores information including processor instructions for calculating visual features for at least one object surface within an environment to determine its suitability for in-situ augmentation with at least one content presentation. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for calculating visual features for at least one object surface within an environment to determine its suitability for in-situ augmentation with at least one content presentation, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 107 for calculating visual features for at least one object surface within an environment to determine its suitability for in-situ augmentation with at least one content presentation to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to calculate visual features for at least one object surface within an environment to determine its suitability for in-situ augmentation with at least one content presentation as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of calculating visual features for at least one object surface within an environment to determine its suitability for in-situ augmentation with at least one content presentation.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to calculate visual features for at least one object surface within an environment to determine its suitability for in-situ augmentation with at least one content presentation. The memory 1105 also stores the data associated with or generated by the execution of the inventive steps.

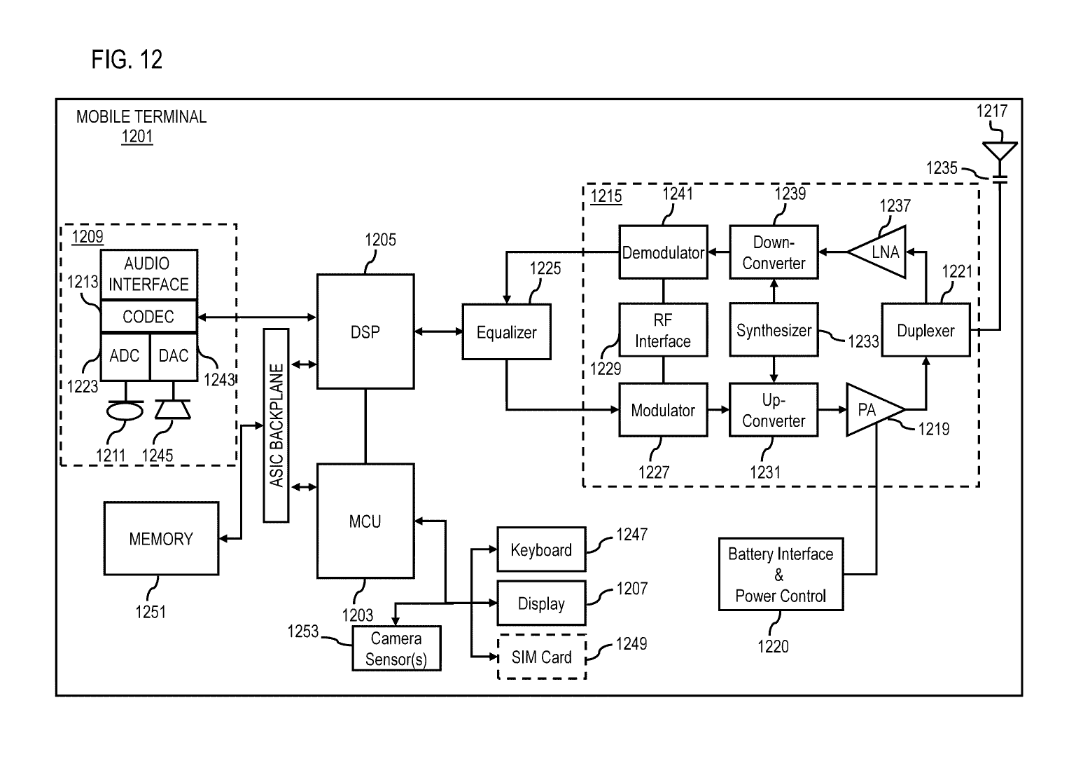

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of calculating visual features for at least one object surface within an environment to determine its suitability for in-situ augmentation with at least one content presentation. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of calculating visual features for at least one object surface within an environment to determine its suitability for in-situ augmentation with at least one content presentation. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to calculate visual features for at least one object surface within an environment to determine its suitability for in-situ augmentation with at least one content presentation. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of three-dimensional mesh data associated with one or more object surfaces depicted in at least one image;
a processing of the three-dimensional mesh data, the at least one image, or a combination thereof to determine one or more visual features of the one or more object surfaces; and
at least one determination of at least one score indicating a suitability for in-situ augmentation of the one or more object surfaces with at least one content presentation based, at least in part, on the one or more visual features.

2. A method of claim 1, wherein the (1) data and/or (2) information and/or (3) at least one signal are further based, at least in part, on the following:
a ranking of the one or more object surfaces based, at least in part, on the at least one score.

3. A method of claim 2, wherein the (1) data and/or (2) information and/or (3) at least one signal are further based, at least in part, on the following:
at least one determination of whether to render the at least one content presentation on at least one of the one or more object surfaces based, at least in part, on the at least one score, the ranking, or a combination thereof.

4. A method of claim 1, wherein the (1) data and/or (2) information and/or (3) at least one signal are further based, at least in part, on the following:
at least one determination of at least one density of the one or more visual features respectively for the one or more object surfaces,
wherein the at least one score is further based, at least in part, on the at least one density of the one or more visual features.

5. A method of claim 1, wherein the (1) data and/or (2) information and/or (3) at least one signal are further based, at least in part, on the following:
a processing of the three-dimensional mesh data to determine at least one noise level with respect to at least one reference surface, at least one reference object, or a combination thereof,
wherein the at least one score is further based, at least in part, on the at least one noise level.

6. A method of claim 1, wherein the (1) data and/or (2) information and/or (3) at least one signal are further based, at least in part, on the following:
a processing of the three-dimensional mesh data, the at least one image, or a combination thereof to determine at least one strength level of the one or more features,
wherein the at least one score is further based, at least in part, on the at least one strength level.

7. A method of claim 1, wherein the (1) data and/or (2) information and/or (3) at least one signal are further based, at least in part, on the following:
a processing of the three-dimensional mesh data, the at least one image, or a combination thereof to determine the one or more features of across a plurality of scales; and
at least one determination of at least one uniformity level of the one or more features across the plurality of scales,
wherein the at least one score is further based, at least in part, on the at least one uniformity level.

8. A method of claim 1, wherein the (1) data and/or (2) information and/or (3) at least one signal are further based, at least in part, on the following:
a processing of the three-dimensional mesh data, the at least one image, or a combination thereof to determine at least one uniqueness level of the one or more features,
wherein the at least one score is further based, at least in part, on the at least one uniqueness level.

9. A method of claim 1, wherein the (1) data and/or (2) information and/or (3) at least one signal are further based, at least in part, on the following:
a processing of the three-dimensional mesh data, the at least one image, or a combination thereof to determine one or more materials making up the one or more object surfaces,
wherein the at least one score is further based, at least in part, on the one or more materials.

10. A method of claim 1, wherein the at least one image includes a plurality of images depicting the one or more object surfaces from one or more viewing angles, under one or more contextual conditions, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine three-dimensional mesh data associated with one or more object surfaces depicted in at least one image;
process and/or facilitate a processing of the three-dimensional mesh data, the at least one image, or a combination thereof to determine one or more visual features of the one or more object surfaces; and
determine at least one score indicating a suitability for in-situ augmentation of the one or more object surfaces with at least one content presentation based, at least in part, on the one or more visual features.

12. An apparatus of claim 11, wherein the apparatus is further caused to:
cause, at least in part, a ranking of the one or more object surfaces based, at least in part, on the at least one score.

13. An apparatus of claim 12, wherein the apparatus is further caused to:
determine whether to render the at least one content presentation on at least one of the one or more object surfaces based, at least in part, on the at least one score, the ranking, or a combination thereof.

14. An apparatus of claim 11, wherein the apparatus is further caused to:
determine at least one density of the one or more visual features respectively for the one or more object surfaces,
wherein the at least one score is further based, at least in part, on the at least one density of the one or more visual features.

15. An apparatus of claim 11, wherein the apparatus is further caused to:
process and/or facilitate a processing of the three-dimensional mesh data to determine at least one noise level with respect to at least one reference surface, at least one reference object, or a combination thereof,
wherein the at least one score is further based, at least in part, on the at least one noise level.

16. An apparatus of claim 11, wherein the apparatus is further caused to:
process and/or facilitate a processing of the three-dimensional mesh data, the at least one image, or a combination thereof to determine at least one strength level of the one or more features,
wherein the at least one score is further based, at least in part, on the at least one strength level.

17. An apparatus of claim 11, wherein the apparatus is further caused to:
process and/or facilitate a processing of the three-dimensional mesh data, the at least one image, or a combination thereof to determine the one or more features of across a plurality of scales; and
determine at least one uniformity level of the one or more features across the plurality of scales,
wherein the at least one score is further based, at least in part, on the at least one uniformity level.

18. An apparatus of claim 11, wherein the apparatus is further caused to:
process and/or facilitate a processing of the three-dimensional mesh data, the at least one image, or a combination thereof to determine at least one uniqueness level of the one or more features,
wherein the at least one score is further based, at least in part, on the at least one uniqueness level.

19. An apparatus of claim 11, wherein the apparatus is further caused to:
process and/or facilitate a processing of the three-dimensional mesh data, the at least one image, or a combination thereof to determine one or more materials making up the one or more object surfaces,
wherein the at least one score is further based, at least in part, on the one or more materials.

20. An apparatus of claim 11, wherein the at least one image includes a plurality of images depicting the one or more object surfaces from one or more viewing angles, under one or more contextual conditions, or a combination thereof.

21.-48. (canceled)
